(19) United States
(12) Patent Application Publication
(10) Pub. No.: US 2018/0163773 A1
(43) Pub. Date: Jun. 14, 2018

(54) DAMPING CONNECTING ROD

(71) Applicant: Airbus Operations SAS, Toulouse (FR)

(72) Inventors: Alain DEPEIGE, TOURNEFEUILLE (FR); Jérôme ANTYPAS, PLAISANCE-DU-TOUCH (FR)

(21) Appl. No.: 15/840,510

(22) Filed: Dec. 13, 2017

(30) Foreign Application Priority Data
Dec. 13, 2016 (FR) 1662374

(51) Int. Cl. F16C 7/04; F16F 7/12; F16F 15/12

(52) U.S. Cl. CPC F16C 7/04; F16F 7/12; F16F 2224/025; F16F 2238/04; F16F 2236/08; F16F 15/1208

(57) ABSTRACT

A damping connecting rod that can be converted into a rigid connecting rod in the case of abnormal vibrations. The damping connecting rod comprises a body having a cavity and a shaft inside the cavity, with a clevis associated with the body and allowing the clevis to be fixed to an element. The shaft can be longitudinally displaced inside the body or the body about the shaft. The connecting rod includes an arrangement for longitudinally immobilizing the shaft with respect to the clevis comprising at least one hook and at least one hollow, which are borne by two connecting rod pieces, respectively, which are configured to be displaced toward one another and with a shape such that, with the displacement of the pieces longitudinally with respect to one another, the hook driven into the corresponding hollow longitudinally immobilizes the shaft with respect to the clevis.

### CROSS-REFERENCES TO RELATED APPLICATIONS

This application claims the benefit of the French patent application No. 1662374 filed on Dec. 13, 2016, the entire disclosures of which are incorporated herein by way of reference.

### BACKGROUND OF THE INVENTION

The present invention concerns the field of connecting rods. The present invention more particularly relates to the damping connecting rods used in the context of the assembly of a device inside a structure in a vibrating environment.

In the context of assembling devices in a structure, vibrations can be produced by the device, per se. Thus, for example, many devices in aircraft such as the engines, pumps, compressors, cooling system, such as that referred to as a VCRU (Vapor Cycle Refrigeration Unit), etc., generate vibrations. Yet, rigid connecting rods, by transmitting the efforts of the device toward the structure, also transmit the vibrations generated by the device. It is also possible that it is the vibrations of the structure, created due to being located in a vibrating environment, which are transmitted to the associated device by means of the rigid connecting rod.

As shown in the patent FR2952150 filed by the present applicant, the connecting rod incorporates means suitable for filtering vibrations; a connecting rod of this type will be called, in the rest of the description, a damping connecting rod since it is suitable for damping the vibrations. The damping connecting rod comprises a primary connecting rod and a secondary connecting rod each including end devises. In the intermediate space, at least one toroidal linking element produced from an elastomeric material is arranged such as to deform and filter vibratory components.

However, it is possible that efforts transmitted by the connecting rod are greater since they result, for example, from a failure causing an abnormal level of vibration. In this case, the range of relative movement permitted by the connecting rod is exceeded and the connecting rod no longer filters the vibrations. However, the displacement along the longitudinal axis from one direction to the other is still permitted by means of the clearances provided at the bores at the end of connecting rods and of the linking element made from deformable material. In these cases which are considered to be abnormal, since the efforts are greatly increased, the strength of the connecting rod is tested.

The aim of the present invention is to propose a damping connecting rod making it possible to improve the strength properties thereof in cases of excessive vibrations.

### SUMMARY OF THE INVENTION

For this purpose, the present invention proposes a damping connecting rod comprising a body having a cavity and a shaft inside the cavity, the connecting rod comprising a clevis associated with the body and allowing fixing to an element and at least partially having a sleeve shape, the body being provided with two bores and the shaft being provided with one bore, which are crossed and held by a fixing axle, the bores having a longitudinal dimension greater than the longitudinal dimension of the axle and the other bores respectively having a tight-fitting dimension such as to allow the displacement of the shaft inside the body or of the body about the shaft, the body being linked to the shaft by a damping element, characterized in that it includes means for immobilizing the shaft with respect to the clevis comprising at least one hook and at least one hollow, which are borne by two connecting rod pieces, respectively, that are able to be displaced toward one another and with a shape such that, with the displacement of the pieces longitudinally with respect to one another, the hook driven into the corresponding hollow immobilizes the shaft with respect to the clevis.

The damping connecting rod has at least one of the following optional features, taken separately or in combination.

An elastic block is placed inside the clevis against a part of the shaft.

The block is made up of an elastic material such that it only deforms under a determined effort applied by the shaft.

The clevis is independent of the body and makes up one of the pieces which bears the hook or hooks and, the corresponding hollow or hollows being made at the body, the other piece that can be displaced longitudinally with respect to the clevis, bores being provided in the clevis for passage of the axle, with a longitudinal dimension greater than the bore.

At least one hook, the curved end of which protrudes with respect to the outer surface of the clevis, is fixed in a hinged manner to the inside of the clevis and held by an elastic snap ring surrounding the clevis and the hook and such that it exerts an effort on the hook making it possible to pivot it radially toward the inside of the clevis along a groove provided therein.

The clevis comprises a recess made in the hook of suitable size to receive the snap ring.

The clevis comprises a tubular part with an external diameter less than the internal diameter of the body and with an internal diameter greater than the external diameter of the part of the shaft such that the part can be inserted between the body and the shaft such as to permit a longitudinal displacement of these with respect to the clevis.

The clevis is produced as a single piece with the body and makes up the first piece including a hollow associated with at least one hook borne by the shaft making up the second piece that be displaced longitudinally with respect to the clevis.

A slotted elastic ring defining hooks between slots is fixed inside the clevis to the shaft about the part thereof.

The present invention also relates to the aircraft comprising a device and a bearing structure linked by a damping connecting rod having at least one of the following optional features, taken separately or in combination.

### BRIEF DESCRIPTION OF THE DRAWINGS

Other aims, advantages and features of the invention will emerge upon reading the following description of the connecting rod according to the invention, given by way of nonlimiting example with reference to the appended drawings wherein:

FIG. 1 shows a planar simplified schematic view of the damping connecting rod installed between a structure and a device;

FIG. 2 shows a schematic sectional view of the damping connecting rod according to a plane passing through the axis of the connecting rod according to an embodiment of the invention;

FIG. 3 shows a simplified schematic view of the connecting rod seen along the arrow F shown in FIG. 2 and highlighting an elastic snap ring for holding the system for immobilizing the connecting rod in rigid mode;

FIG. 4 shows a schematic sectional view of the damping connecting rod along a plane passing through the axis of the connecting rod according to another embodiment of the invention;

FIG. 5 shows a simplified schematic view of a slotted ring of the system for immobilizing the connecting rod shown in FIG. 4 in rigid mode;

FIG. 6 shows an enlarged sectional simplified schematic view of a part of the immobilizing system of FIGS. 2 and 3, which system is made reversible;

FIG. 7 shows a sectional simplified schematic view along the axis Y-Y of FIG. 6;

FIG. 8 shows a perspective view of an embodiment of the immobilizing system wedge shown in FIGS. 6 and 7;

FIG. 9 shows a perspective view of another embodiment of the immobilizing system wedge shown in FIGS. 6 and 7.

### DETAILED DESCRIPTION OF THE PREFERRED EMBODIMENTS

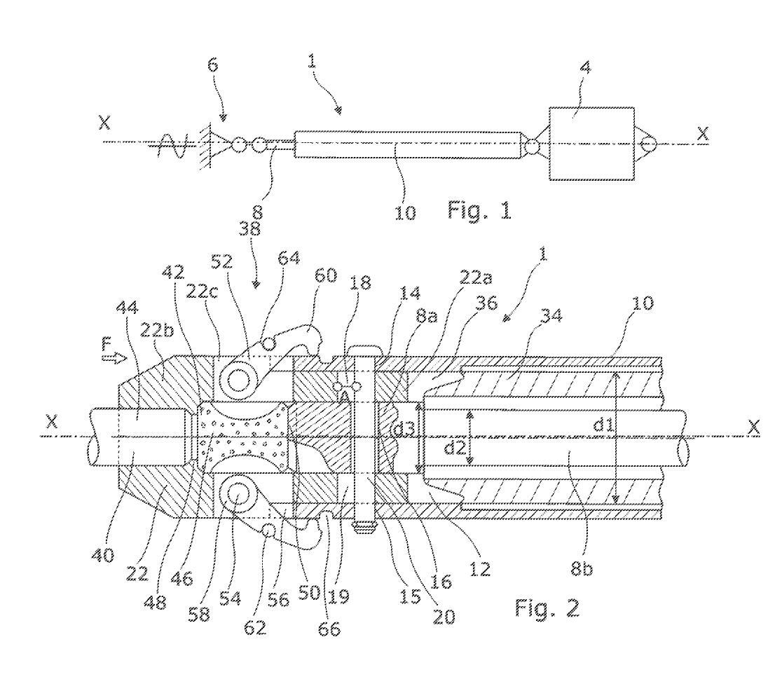

As shown in FIG. 1, the present invention relates to a connecting rod 1 used to assemble a device 4 on a bearing structure 6 in a vibrating environment. The term “element” will be used to generally designate the device, the bearing structure or any other object on which each of the ends of the connecting rod is fixed. The described connecting rod has many and varied uses. For example, the installation of devices on an aircraft is a possible use. Indeed, an aircraft offers an environment presenting several types of vibrations. Thus, for example, many devices 4 are hinged to the structure 6 of the aircraft particularly by means of connecting rods 1 like the landing gear, the engine pylons, the floor, the wing box, etc. Yet, the vibrations in an aircraft are sources of annoyance for the passengers due to the physical and sound effects produced. It is, therefore, known to use damping connecting rods 1 for filtering vibrations that are considered to be normal. Vibrations are said to be normal when they occur in a normal operation configuration, namely without a failure or unexpected event.

The damping connecting rod 1 includes a shaft 8 and a body 10 coaxial about a longitudinal axis X-X. The body is at least partially hollow such as to have a cavity 12 inside which the shaft 8 can be placed such that the shaft 8 can move in the direction of the axis X-X inside the body 10 or the body 10 can move in the direction of the axis X-X about the shaft 8. The shaft 8 can be solid or hollow or have a complex shape having solid and hollow parts.

In the embodiments illustrated in FIGS. 2-5, the body 10 and the shaft 8 are cylindrical with a circular section. The hollow body 10 has an internal diameter dl which is greater than the diameters of the various parts of the shaft to allow the displacement of the shaft inside the body or of the body about the shaft, such as the diameters, for example, designated by the references d2, d3 shown in the figures.

The body 10 has two diametrically opposite through-bores 14, 15, respectively, (FIGS. 2 and 4). The shaft 8 has a through-bore 16 (FIGS. 2 and 4). The bores 14, 15, 16 of the body and of the shaft are matched up for passage of a fixing axle 20. The connecting rod 1 includes a clevis 22 for fixing the connecting rod to an element in the form, in the usage example mentioned above, of a device 4 or of a bearing structure 6. The clevis 22 at least partially has a sleeve shape.

According to the embodiment illustrated in FIG. 2, the clevis 22 is independent of the body 10. The clevis 22 is provided with two diametrically opposite bores 18, 19 matched up with the bores 14, 15 of the body and the bore 16 of the shaft. The body 10, the shaft 8 and the clevis 22 are bound using the axle 20. The diameter of the bores 14, 15 made in the body 10 are matched to that of the axle 20 such that the axle can fit into the bores 14, 15 and rigidly hold the body 10. The bores 18, 19 made in the clevis 22 have a longitudinal dimension and, in this case, in view of the circular section of the axle and of the bores, a diameter greater than those 14, 15 of the body 10 and, therefore, greater than the diameter of the axle 20. In this manner, once the axle 20 has been installed, the body can be displaced along the longitudinal axis X-X over a range determined by the diameter of the bores 18, 19. The longitudinal displacement of the body is stopped in both directions by the abutment of the fixing axle 20 against the edges of the bores 18, 19 of the clevis 22. Moreover, the bore 16 made in the shaft 8 has a longitudinal dimension and, in this case, in view of the circular section of the axle and of the bores, a diameter greater than those 14, 15 of the body 10 and, therefore, greater than the diameter of the axle 20. In this manner, once the axle 20 has been installed, the body can move along the longitudinal axis X-X over a range determined by the diameter of the bore 16. As the longitudinal dimension, namely in this case the diameter, of the bores 18, 19 is greater than the longitudinal dimension, namely in this case the diameter, of the bore 16, when the displacement of the body 10 drives the axle into abutment against the edges of the bore 16 of the shaft 8, the shaft is then translated with the body 10. The displacement of the assembly formed by the body and the shaft is then stopped by the edges of the bores 18, 19.

In the embodiment illustrated in FIG. 4, the longitudinal dimension, namely in this case the diameter of the bore 16 made in the shaft 8, is matched to the longitudinal dimension or, in this case the diameter of the axle 20, such that the axle can fit into the bore 16 and rigidly hold the shaft 8. The bores 14, 15 made in the body have a longitudinal dimension, namely in this case a diameter, greater than the longitudinal dimension, in this case the diameter, of the shaft 8 and, therefore greater than the diameter of the axle 20. As a result of having a diameter greater than the axle 20, two friction washers 24, 26 are provided on either side of the body 10. The washers 24, 26 have an external diameter greater than the diameter of the bores 14, 15 such as to provide a support to the elements provided to lock and hold the axle 20 in place. In the illustrated embodiment, the holding elements are, on one side of the body, the head 28 of the axle 20, and on the other side, an elastic ring 30. The central hole of the washer has, in this case, an oblong shape in order to only allow a longitudinal displacement of the axle 20. In this manner, once the axle 20 has been installed, the shaft 8 can be displaced along the longitudinal axis X-X over a range determined by the diameter of the bores 14, 15. The longitudinal displacement of the shaft is stopped in both directions by the abutment of the fixing axle 20 against the edges of the bores 14, 15 of the body.

To prevent the transmission of vibrations, and in the illustrated case from the structure 6 to the device 4 or vice versa, the connecting rod 1 is provided with a damping element 34. The element 34 is inserted into a free space 36 of the cavity 12 between the shaft 8 and the body 10 and fixed to these by any type of known means, namely by sticking, fixing by rivets, interlocking, etc. The element 34 comprises at least a part made from elastic deformable material, for example rubber or plastic. The element 34 has any type of shape and, in the example illustrated, the element 34 has a loop shape, the external surface of which is placed right next to and fixed to the body 10, and the internal surface of which is placed right next to and fixed to the shaft 8.

The damping element 34 makes it possible to absorb the very slight movements of the element such as, for example, of the bearing structure 6 and/or of the device 4 due to vibrations and more particularly the longitudinal displacements of the shaft with respect to the body or vice versa by placement therebetween. The connecting rod 1 is said to be a damping connecting rod.

However, in an aircraft, infrequent situations can arise in which the vibrations reach an intensity such that it is no longer possible to damp them. For example, the accidental damage to a rotating part of an engine can require the engine concerned to stop. Due to the wind, the engine nevertheless continues to rotate and there is an engine imbalance. The engine imbalance is a source of vibrations having a high intensity. According to another example of a situation, a low quality ground surface can create significant vibrations when the aircraft is taxiing.

The connecting rod movements caused by vibrations of a magnitude such that they are described as abnormal, stress the structure thereof and test the strength thereof. The connecting rod 1 is no longer able to absorb excessive ranges of movement. In order to prevent such stresses, the damping connecting rod 1 is provided with means for making it rigid when the effort exerted on the connecting rod reaches a determined threshold. More precisely, the damping connecting rod 1 is provided with a system 38 for immobilizing the shaft against translation with respect to the clevis or vice versa, thus making it possible to rigidify the connecting rod. As a result of the rigidly thereof, the transmission of the efforts by the connecting rod 1 is increased which improves the strength thereof The connecting rod 1 loses the elastic properties thereof which made it possible to filter so-called normal vibrations in order to gain strength with respect to the increased efforts produced by so-called abnormal vibrations.

The immobilizing system 38 must only be actuated when the effort exerted on the connecting rod is such that a determined range A of displacement is reached. The immobilizing system 38 can have any form, namely hook, balls, etc., allowing the shaft 8 to be locked against translation with respect to the clevis 22 or vice versa, when the range A is reached.

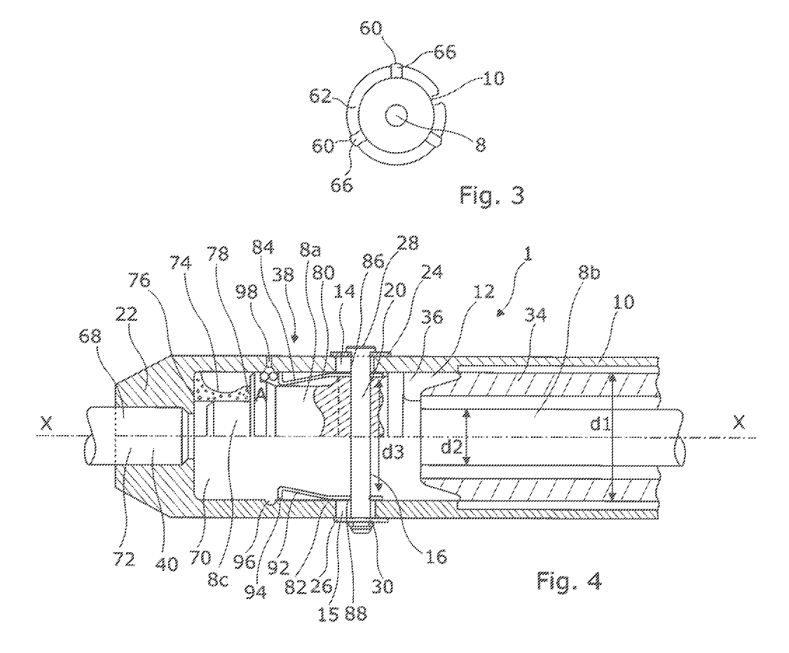

FIGS. 2 and 3 show a first possible embodiment of a system 38 for immobilizing the damping connecting rod.

The shaft 8 has two portions 8a and 8b with different diameters. It could include more than two portions with different diameters. The end portion 8a with the greatest diameter is reinforced given that the fixing axle 20 passes therethrough.

The clevis 22 has a complex shape for linking with an element such as a device or a bearing structure and for receiving a part of the immobilizing system 38. The clevis 22 comprises three parts: an end part 22a on the body 10 side, an end part 22b opposite the part 22a, and an intermediate part 22c between the parts 22a and 22b.

The clevis 22 has, at one of the ends 22a thereof, the end which is intended to link with the body 10 and the shaft 8, a tubular shape with a circular section with a reduced external diameter. The external diameter of the end 22a of the clevis 22 is slightly less than the internal diameter of the body 10 and such that the external surface of the part 22a of the clevis can be placed right next to the internal surface of the body 10 while allowing the displacement of the clevis with respect to the body. The internal diameter of the end 22a of the clevis 22 is greater than the external diameter of the part 8a of the shaft 8 and such that the internal surface of the end 22a of the clevis can be placed right next to the external surface of the part 8a of the shaft while allowing the displacement of the shaft with respect to the clevis.

Thus, the clevis 22 fits between the body 10 and the part 8a of the shaft 8 and particularly makes it possible to guide the displacement of the body 10 about the shaft 8 and more precisely along the longitudinal axis X-X. The clevis 22 is retained inside the body using the fixing axle 20.

As a result of being inserted between the body 10 and the shaft 8, the clevis 22 provides a centering and guiding function in the displacement of the body 10 about the shaft 8.

The bores 18, 19 provided at the clevis 22 allow longitudinal travel of the axle.

The external diameter of the parts 22c and 22b of the clevis 22, at least partially, is identical to the external diameter of the body 10 such as to provide a continuous connecting rod overall external surface, in particular in the zone of the joint between the clevis 22 and the body 10. The part 22b of the clevis 22 has, at least partially, a changing external diameter that diminishes in the direction of the end of the connecting rod in order to have, for example, an external surface shaped like a truncated cone.

The end portion 22b of the clevis opposite that end 22a inserted between the body and the shaft comprises two adjacent and coaxial cylindrical internal zones 40, 42 having a circular section with a different diameter: a zone 40 opening at one of the ends of the connecting rod, the diameter of which is suitable for an arm 44 for fixing with the latter by screwing, and a zone 42 opening on the other side of the clevis with a diameter greater than the diameter of the zone 40, the transition between the two zones being located at the part 22b. The arm 44 could be produced as a single piece with the clevis 22 or fixed thereto by other means. The arm 44 makes it possible to link with the element and, for example, the device or the bearing structure.

According to the embodiment in FIG. 2, the connecting rod comprises an elastic material circular section cylindrical block 46 fitted inside the clevis 22. In the illustrated example, the external diameter varies continuously in a longitudinal manner such as to produce a central contraction: the diameter of the block decreases symmetrically from the two-end transverse faces 48, 52 up to a central section of symmetry. The block 46 could alternatively be made up of a spring, of spring washers of Belleville washer type, etc. The maximum diameter of the central block 46 corresponds to the internal diameter of the zone 42 of the clevis, but slightly less such as to fit inside the latter. One of the transverse faces 48 of the block 46 adjoins the zone 40 of the clevis and cannot fit therein due to the smaller diameter of this zone. The other transverse face 50 opposite the face 48 is placed right next to the end of the shaft 8 when the clevis is installed on the body 10. The material of the block 46 has a stiffness coefficient such that it only deforms from a certain threshold for an effort exerted thereon. Thus, under the effect of abnormal vibrations, the body 10 exerts an effort on the shaft 8 by means of the axle 20, which effort is greater than a threshold such that the material of the block 46 deforms under the effort exerted by the shaft 8 driven by the body 10, and the body 10 and the shaft 8 are then displaced with respect to the clevis 22 along the longitudinal axis X-X.

The immobilizing system 38 includes at least one outer hook 52 bound in a rotatably hinged manner by one of the ends thereof to the clevis 22. The hinge axle 54 is positioned inside the clevis. A groove 56 is provided in the clevis 22 for passage of the hook inside the latter when the hook pivots. The hook 52 has an enlarged end 58 at which the rotational hinge axle 54 is provided and another curved end 60 forming a hook opposite the enlarged end 58. A retaining elastic snap ring 62 encircles the clevis 22 by passing over the hook 52. A recess 64 is provided at the external face of the hook 52 with a dimension corresponding to that of the snap ring 62. The snap ring 62 is held in position on the hook by the recess 64 into which it fits. The snap ring 62 is made up of an elastic material. The dimensions of the snap ring 62 are chosen such as to allow the snap ring 62, once installed in the recess 64, to hold the curved end 60 of the hook 52 against the body 10 and push the hook 52 in a radial direction toward the clevis 22.

When the effort exerted on the connecting rod is such that the material of the block 46 is compressed and the body 10 moves about the clevis 22, the curved end 60 of the hook 52 slides along the external surface of the body until it corresponds with a cavity, slot or any other type of hollow 66 provided at the external face of the body. When the curved end 60 of the hook arrives at the same level as the hollow 66 produced in the body, the hook pivots in the groove 56 toward the inside of the clevis and the curved end 60 fits into the hollow 66 of the body 10 with a profile suitable for receiving the end 60.

The longitudinal dimension of the block 46 determines the distance between the curved end 60 of the hook and the body and therefore the range A of displacement. By changing the block 46 inside the connecting rod, it is possible to modify the range A of displacement according to the use made of the connecting rod 1.

In the embodiment of FIGS. 2 and 3, the clevis 22 is provided with three hooks 52 spread at an equal distance about the clevis 22.

The connecting rod 1 according to the embodiment illustrated in FIGS. 2 and 3 operates in the following manner

When the connecting rod is subjected to abnormal vibrations, the block 46 is compressed under the effort exerted by the shaft 8. The dimensions of the bores 18 and 19 of the clevis permit the longitudinal displacement of the body about the part 22a of the clevis. The curved end of each of the hooks 52 moves closer to the corresponding hollows 66. When the curved end of each of the hooks arrives at the level of the corresponding hollows 66, the elastic snap ring 62 drives the curved end of each of the hooks inside the hollows 66: the body is then locked against translation. The connecting rod becomes a rigid connecting rod since the body can no longer move about the shaft. The immobilizing system is irreversible unless the connecting rod is acted upon manually.

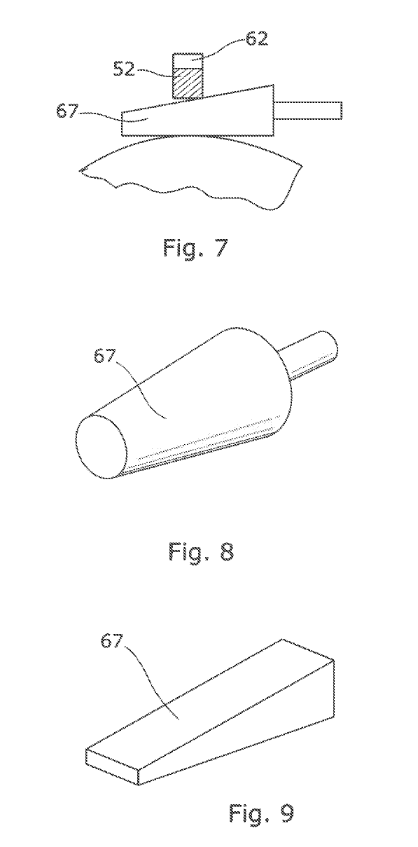

According to an embodiment shown in FIGS. 6 to 9, the immobilizing system can be made reversible using wedges 67. As is shown in FIGS. 6 and 7, a wedge is fitted between each hook 52 and the body 10 inside the hook. Thus, when the curved end of each of the hooks fits into the hollows 66, the wedges 67 make it possible to remove the hook from the body 10. As shown in FIGS. 8 and 9, the shape of the wedge 67 can be varied. In FIG. 8, the wedge is shaped like a truncated cone. In FIG. 9, the wedge has two opposite rectangular parallel faces linked by two rectangular opposite side faces and two trapezium-shaped opposite side faces.

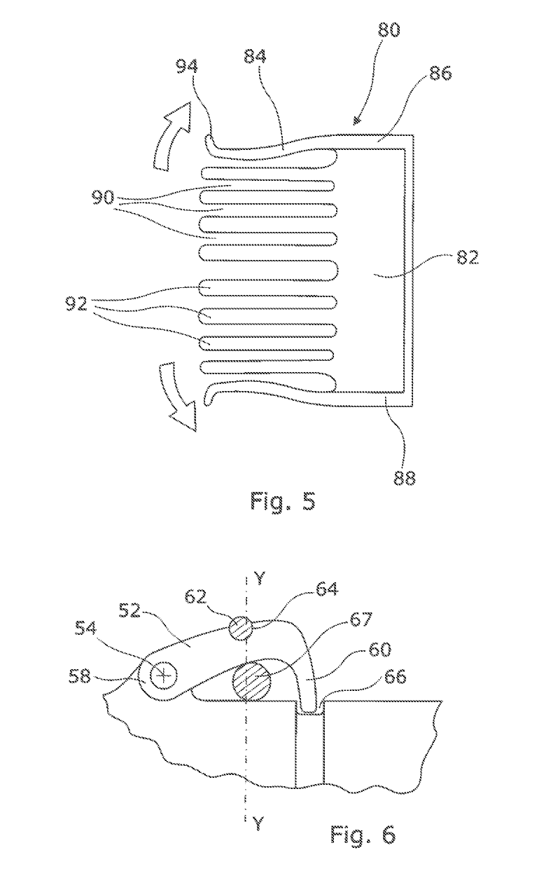

FIGS. 4 and 5 show another possible embodiment of the immobilizing system 38.

The shaft 8 has two portions 8a, 8b with different diameters. In this embodiment, an additional end portion 8c is provided. The portion 8a with the largest diameter, which is reinforced for passage of the fixing axle 20, becomes, in this embodiment, an intermediate portion between the portions 8b and 8c. The end portion 8c has a diameter less than that of the intermediate portion 8a.

The clevis 22 for linking to an element such as a device or a bearing structure is produced as a single piece with the body 10. The clevis 22 designates, in this case, the end of the body 10 beyond the bores 14, 15 in the direction of the axis X-X.

The clevis 22 comprises two adjacent and coaxial tubular internal zones 68, 70 having a circular section with a different internal diameter: a zone 68 opening on one side of the connecting rod, the diameter of which is suitable for an arm 72 for fixing with the latter by screwing and a zone 70 with a diameter greater than the diameter of the zone 68. The arm 72 could be produced as a single piece with the clevis 22 or fixed thereto by any type of means. The arm 72 makes it possible to link to the element.

According to the embodiment of FIG. 4, the connecting rod comprises a loop-shaped block 74 made of elastic material which is fitted inside the body 10 in the zone 70 of the clevis 22. The external diameter of the loop varies continuously in a longitudinal manner such as to produce a central contraction. According to other possible embodiments, the block could be made up of a spring, spring washers, etc. The external diameter of the block 74 corresponds to the internal diameter of the zone 70 of the clevis, but slightly less such as to fit inside the latter. The internal diameter of the block 74 corresponds to the external diameter of the end portion 8c of the shaft. One of the transverse faces 76 of the block 74 adjoins the zone 68 of the clevis and cannot fit therein due to the smaller diameter of the zone 68. The other transverse face 78 opposite the face 76 is placed right against the free surface of the end of the portion 8a of the shaft 8, namely the loop-shaped surface located at the periphery of the linking section between the portions 8a and 8c of the shaft. The block 74 surrounds and is placed right against the external surface of the end portion 8c of the shaft 8. The external diameter of the portion 8c of the shaft 8 is slightly less than the internal diameter of the block 74 such that the block 74 envelopes the portion 8c. The portion 8c thus allows the block 74 to be held in place inside the clevis 22. The material of the block 74 has a stiffness coefficient such that it only deforms from a specific effort exerted thereon. Thus, under the effect of abnormal vibrations, the shaft 8 exerts an effort on the block 74, which effort is greater than a threshold such that the material of the block 74 deforms under the effort exerted by the shaft 8, and the shaft 8 then slides inside the body 10 along the longitudinal axis X-X.

In this embodiment, the bores 14, 15 provided at the body 22 allow longitudinal travel of the axle, and a slight movement of the shaft with respect to the body.

The immobilizing system 38 includes a slotted ring 80, which is at least partially elastic, inside the clevis 22 and the body 10. The circular section cylindrical ring 80 has a solid part 82 and a slotted elastic part 84. The solid part has a diameter that is less than the internal diameter of the body 10 and greater than the external diameter of the shaft 8 and more precisely of the intermediate part 8a. The part 82 is inserted and is held between the body and the shaft, longitudinally at the bores 14 and 15 of the body 10. The solid part 82 of the ring 80 has two diametrically opposite bores 86, 88 with a diameter corresponding to the diameter of the fixing axle 20 such that the axle passes through the ring 80. The fixing axle 20 passes through the body 10, the ring 80 and the shaft 8. The slotted part 84 has a series of longitudinal parallel slots 90 forming, between each slot, elastic hooks 92 with an end 94 curved toward the outside of the ring.

The ring, at least at the slotted part 84, is made up of an elastic material allowing the curved end 94 of the hooks 92 to be pushed radially toward the inside of the clevis, by the internal wall thereof. As a result, the shaft 8 has, in line with the hooks 92, a contraction making it possible to house them inside the clevis 22. When the effort against the connecting rod is such that the material of the block 74 is compressed and that the shaft 8 is displaced longitudinally inside the clevis 22, the curved end 94 of the hooks 92 slides along the internal surface of the body until coming into correspondence with a cavity, slot or any other type of hollow 96 produced on the entire perimeter of the internal face of the clevis. When the curved end 94 of the hooks reaches the same level as the hollow 96 produced in the clevis 22, the curved end 94 fits into the hollow 96 having a profile suitable for receiving the end 94. A through-opening 98 is made in the clevis 22 located longitudinally at the hollow 96 in order to allow the passage of a tool such as a needle.

The longitudinal dimension of the block 74 determines the distance between the curved end 94 of the hook and the hollow 96 of the clevis, namely the range A of displacement. By changing the block 74 inside the connecting rod, it is possible to modify the amplitude A of displacement according to the use made of the connecting rod 1.

The connecting rod 1 according to the embodiment illustrated in FIGS. 4 and 5 operates in the following manner

When the connecting rod is subjected to abnormal vibrations, the block 74 is compressed under the effort exerted by the shaft 8. The dimensions of the bore 14 of the body 10 permit the longitudinal displacement of the shaft inside the body and the clevis. The curved end of each of the hooks moves closer to the corresponding hollows 96. When the curved end of each of the hooks reaches the level of the corresponding hollows 66, the curved end 94 of each of the hooks fits inside the hollows 96: the shaft is then locked against translation with respect to the clevis and to the body. The connecting rod becomes a rigid connecting rod since the shaft can no longer move inside the body. Unlike the previous embodiment, the immobilizing system is reversible: by fitting a needle borne by a specific tool into the opening 98, the needle pushes back the curved end 94 of the hooks toward the inside of the body out of the hollow 96. The tool also makes it possible to match up, at the same time, all of the needles with the openings 98.

Such a connecting rod can be used in many ways. By way of illustration, in an aircraft, many rigid connecting rods allow devices to be fixed to a bearing structure of the aircraft and, for example, the fuselage. The replacement of such rigid connecting rods with convertible damping connecting rods not only makes it possible to filter slight vibrations in normal mode using the damping function thereof, but also to improve the fatigue strength following the occurrence of excessive vibrations due to the system for converting a damping connecting rod into a rigid connecting rod.

As seen above, the present invention is not limited to the aeronautical field. The connecting rod 1 could be used in many other technical fields in which it is beneficial to have a connecting rod with the aforementioned advantages.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A damping connecting rod comprising:
a body having a longitudinal cavity and a shaft inside the cavity,
a clevis associated with the body and allowing fixing to an element and at least partially having a sleeve shape,
the body being provided with two first bores and the shaft being provided with one second bore, which are crossed and held by a laterally extending fixing axle,
either the first or second bores having a longitudinal dimension greater than a longitudinal dimension of the axle and the other of the first or second bores having a tight-fitting dimension, such as to allow the longitudinal displacement of the shaft inside the body or of the body about the shaft,
the body being linked to the shaft by a damping element,
means for immobilizing the shaft with respect to the clevis comprising at least one hook and at least one hollow, which are borne by two connecting rod pieces, respectively, that are configured to be displaced toward one another and with a shape such that, with the displacement of the pieces longitudinally with respect to one another, the hook driven into the corresponding hollow longitudinally immobilizes the shaft with respect to the clevis.

2. The connecting rod according to claim 1, wherein an elastic block is placed inside the clevis against a part of the shaft.

3. The connecting rod according to claim 2, wherein the block is fabricated of an elastic material such that the block only deforms under a predetermined level of force applied by the shaft.

4. The connecting rod according to claim 1, wherein the clevis is independent of the body and comprises one of the pieces which bears the at least one hook, the corresponding at least one hollow being located in the body, the other piece that is configured to be displaced longitudinally with respect to the clevis, the two first bores being provided in the clevis for passage of the axle, with a longitudinal dimension greater than the second bore.

5. The connecting rod according to claim 4, wherein at least one hook, the curved end of which protrudes with respect to the outer surface of the clevis, is fixed in a hinged manner to an inside of the clevis and held by an elastic snap ring surrounding the clevis and the hook and such that the elastic snap ring exerts a force on the hook allowing the hook to pivot radially toward the inside of the clevis along a groove provided therein.

6. The connecting rod according to claim 5, wherein the clevis comprises a recess made in the hook of suitable size to receive the snap ring.

7. The connecting rod according to claim 5, wherein the clevis comprises a tubular part with an external diameter less than an internal diameter of the body and with an internal diameter greater than an external diameter of a reduced diameter part of the shaft such that the reduced diameter part can be inserted between the body and the shaft, such as to permit a longitudinal displacement of the body and the shaft with respect to the clevis.

8. The connecting rod according to claim 1, wherein the clevis is produced as a single piece with the body and makes up a first of the two rod pieces including a hollow associated with at least one hook borne by the shaft making up the second of the two rod pieces that is configured to be displaced longitudinally with respect to the clevis.

9. The connecting rod according to claim 8, wherein a slotted elastic ring defining hooks between slots is fixed inside the clevis to the shaft about the reduced diameter part thereof.

10. An aircraft comprising a device and a bearing structure linked by a damping connecting rod according to claim 1.
